(19) United States
(12) Patent Application Publication
(10) Pub. No.: US 2013/0343064 A1
(43) Pub. Date: Dec. 26, 2013

(54) LAMP STRUCTURE

(71) Applicant: TAIWAN FU HSING INDUSTRIAL CO., LTD., Kaohsiung City (TW)

(72) Inventors: Shun-Ho Wu, Kaohsiung City (TW); Chih-Cheng Huang, Kaohsiung City (TW)

(73) Assignee: TAIWAN FU HSING INDUSTRIAL CO., LTD., Kaohsiung City (TW)

(21) Appl. No.: 13/661,385

(22) Filed: Oct. 26, 2012

(30) Foreign Application Priority Data
Jun. 22, 2012 (TW) 101122532

(51) Int. Cl. F21V 29/00

(52) U.S. Cl. 362/373

(57) ABSTRACT

A lamp structure includes a case, a fixing base and a plurality of heat dissipation members. The fixing base is disposed at the case and comprises a carrier. The heat dissipation members are coupled to the fixing base, wherein a heat exchange space is defined between adjacent heat dissipation members. The heat produced from the lamp structure can be dissipated through the heat dissipation members and the heat exchange space so as to increase heat dissipation efficiency of the lamp structure. Therefore, the present invention prevents the lamp structure from overheat to avoid a relatively lower optoelectronic conversion efficiency or destruction.

### FIELD OF THE INVENTION

The present invention is generally related to a lamp structure, which particularly relates to the lamp structure with heat dissipation members.

### BACKGROUND OF THE INVENTION

With reference to FIG. 12, a convention lamp structure 10 includes a base 11, a substrate 12 and a lighting module 13, wherein the substrate 12 is disposed on the base 11. The lamp structure 10 produces massive heat and is not able to dissipate heat when the lamp structure 10 is in use, which results in a lower lighting efficiency or destruction of the lighting module 13 through rising temperature.

### SUMMARY

The primary object of the present invention is to provide a lamp structure with heat dissipation members to overcome a lower lighting efficiency or destruction of a conventional LED lamp caused by overheat from the LED lamp.

A lamp structure of the present invention includes a case, a fixing base and a plurality of heat dissipation members, wherein the case comprises a substrate and an accommodating chamber surrounded by the substrate. The fixing base is disposed at the case and comprises a carrier having an opening formed around a longitudinal axis. The heat dissipation members are arranged alternately from each other along the longitudinal axis and couple to the fixing base, wherein a heat exchange space is defined between adjacent heat dissipation members. By means of thermal coupling between the fixing base and the heat dissipation members, the heat produced by the lamp structure can be conducted to the heat dissipation members through the fixing base and thereafter dissipates via the heat exchange space to prevent the lamp structure from overheat to avoid a relatively lower opto-electronic conversion efficiency or destruction.

### DESCRIPTION OF THE DRAWINGS

FIG. 1 is a perspective exploded diagram illustrating a lamp structure in accordance with a first embodiment of the present invention.

FIG. 2 is a section view illustrating a lamp structure in accordance with a first embodiment of the present invention.

FIG. 3 is a section view illustrating a fixing base and a plurality of heat dissipation members in accordance with a first embodiment of the present invention.

FIG. 4 is a perspective exploded diagram illustrating a lamp structure in accordance with a second embodiment of the present invention.

FIG. 5 is a section view illustrating a fixing base and a plurality of heat dissipation members in accordance with a second embodiment of the present invention.

FIG. 6 is a perspective exploded diagram illustrating a lamp structure in accordance with a third embodiment of the present invention.

FIG. 7 is a section view illustrating a fixing base and a plurality of heat dissipation members in accordance with a third embodiment of the present invention.

FIG. 8 is a section view illustrating a fixing base and a plurality of heat dissipation members in accordance with a fourth embodiment of the present invention.

FIG. 9 is a bottom view of FIG. 8.

FIG. 10 is a section view illustrating a fixing base and a plurality of heat dissipation members in accordance with a fifth embodiment of the present invention.

FIG. 11 is a bottom view of FIG. 10.

FIG. 12 is a schematic diagram of a conventional lamp structure.

### DETAILED DESCRIPTION OF THE INVENTION

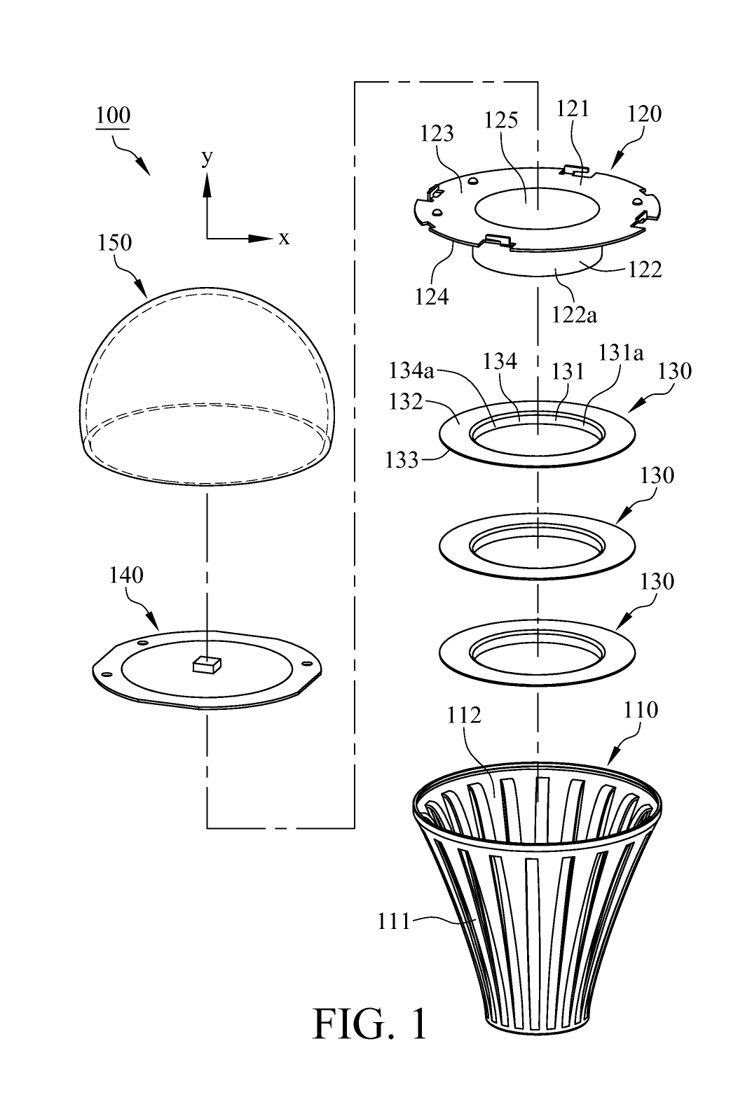

With reference to FIGS. 1, 2 and 3, a lamp structure 100 in accordance with a first embodiment of the present invention includes a case 110, a fixing base 120, a plurality of heat dissipation members 130, a lighting module 140 and a lamp cover 150, wherein the case 110 comprises a base 111 and an accommodating chamber 112 surrounded by the base 111. The fixing base 120 is disposed at the case 110 and comprises a carrier 121 and an extending portion 122, the carrier 121 comprises an upper surface 123, a lower surface 124 and an opening 125 formed around a longitudinal axis y. The extending portion 122 located at the accommodating chamber 112 extends along the longitudinal axis y and protrudes to the lower surface 124. The extending portion 122 comprises a coupling surface 122a. In this embodiment, the extending portion 122 extends from the opening 125, wherein the extending portion 122 is formed as one piece with the fixing base 120 by means of stamping process.

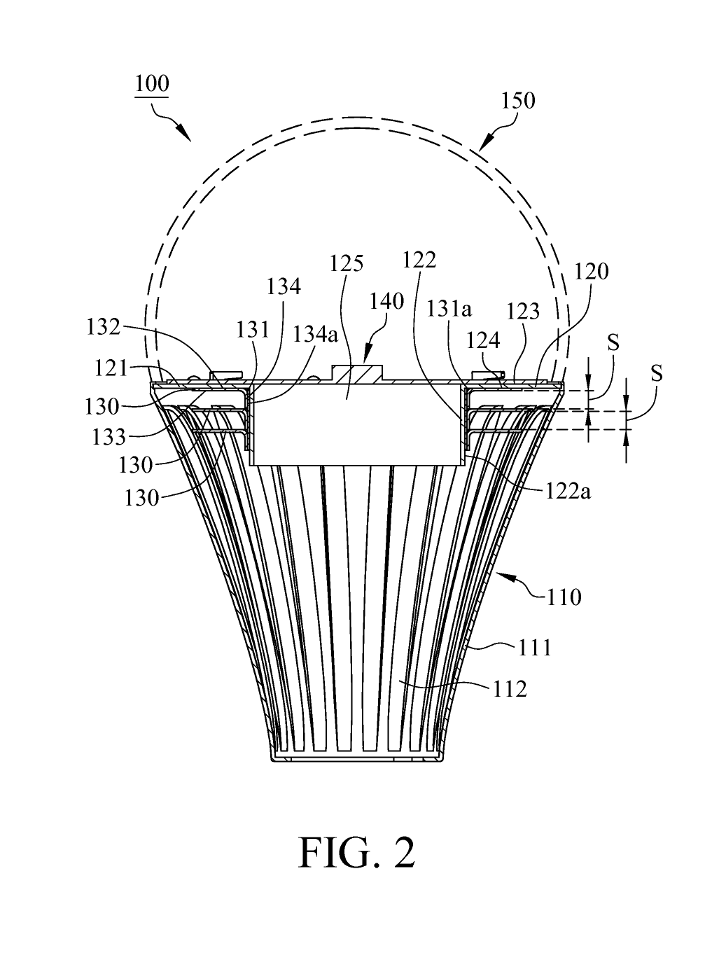

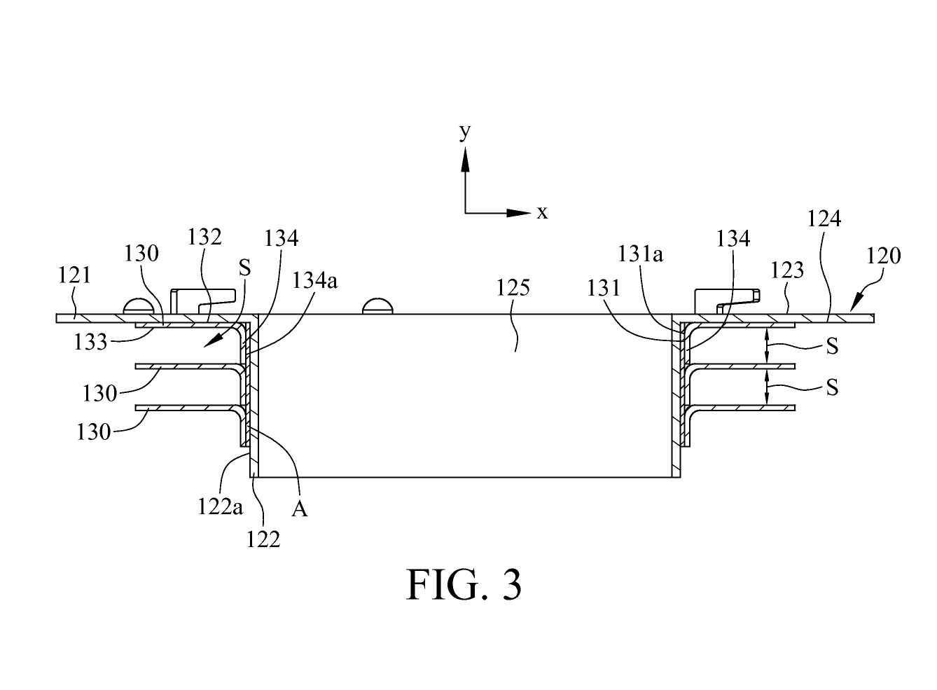

With reference to FIGS. 2 and 3 again, the heat dissipation members 130 are arranged alternately from each other along the longitudinal axis y and couple to the fixing base 120, wherein a heat exchange space S is defined between adjacent heat dissipation members 130. In this embodiment, the heat dissipation members 130 are coupled to the extending portion 122 of the fixing base 120. Each heat dissipation member 130 comprises a connection hole 131, a first surface 132, a second surface 133 and an extending wall 134 formed around the longitudinal axis y, wherein the extending wall 134 is coupled to the fixing base 120. The connection hole 131 comprises a connection surface 131a coupled to the coupling surface 122a of the extending portion 122. In this embodiment, the first surface 132 of the heat dissipation member 130 adjacent to the carrier 121 is in contact with the carrier 121 of the fixing base 120, and the extending wall 134 is extendedly formed from a hole surface of the connection hole 131. The lighting module 140 is disposed on the upper surface 123 of the fixing base 120. In this embodiment, the lighting module 140 is a single light emitting diode, or, the lighting module 140 is a plurality of light emitting diodes.

With reference to FIGS. 2 and 3 again, in this embodiment, each extending wall 134 comprises an inner surface 134a coupled to the coupling surface 122a of the extending portion 122, preferably, the lamp structure 100 further includes a conductive glue layer A between the inner surface 134a and the coupling surface 122a, and the conductive glue layer A is thermal conductive gel or thermal grease. The conductive glue layer A may increase the heat conducting efficiency of the heat dissipation member 130 and the fixing base 120. Via thermal coupling between the heat dissipation member 130 and the fixing base 120, the heat produced by the lighting module 140 can be conducted to the heat dissipation member 130 through the fixing base 120, and thereafter, the heat dissipates from the heat exchange space S. The present invention not only utilizes the heat dissipation members 130 to expand heat dissipation surface area for raising heat conducting effectiveness, but also utilizes the heat exchange space S existed between adjacent heat dissipation members 130 to rapidly dissipate heat produced from surfaces of the heat dissipation members 130 by means of heat convection. Therefore, a heat dissipation function can be effectively achieved.

Except that, the present invention does not limit the quantity of the heat dissipation member 130. That is to say, the quantity of the heat dissipation member 130 is adjustable corresponding to heat energy level of the lighting module 140. Besides, the manufacturer simply fabricates the heat dissipation member 130 with one size to adapt to all kinds of heat energy distributions, which effectively lowers design, fabrication and storage costs.

In this embodiment, the heat dissipation members 130 are arranged with equal spacing, which merely shows one design option of the present invention. In another design option, the heat dissipation members 130 can be arranged with non-equal spacing according to heat energy distributions. For instance, the closer the heat dissipation members 130 are to the lighting module 140, the denser the arrangement between adjacent heat dissipation members 130 is required for increasing heat dissipation surface area to dissipate heat energy rapidly.

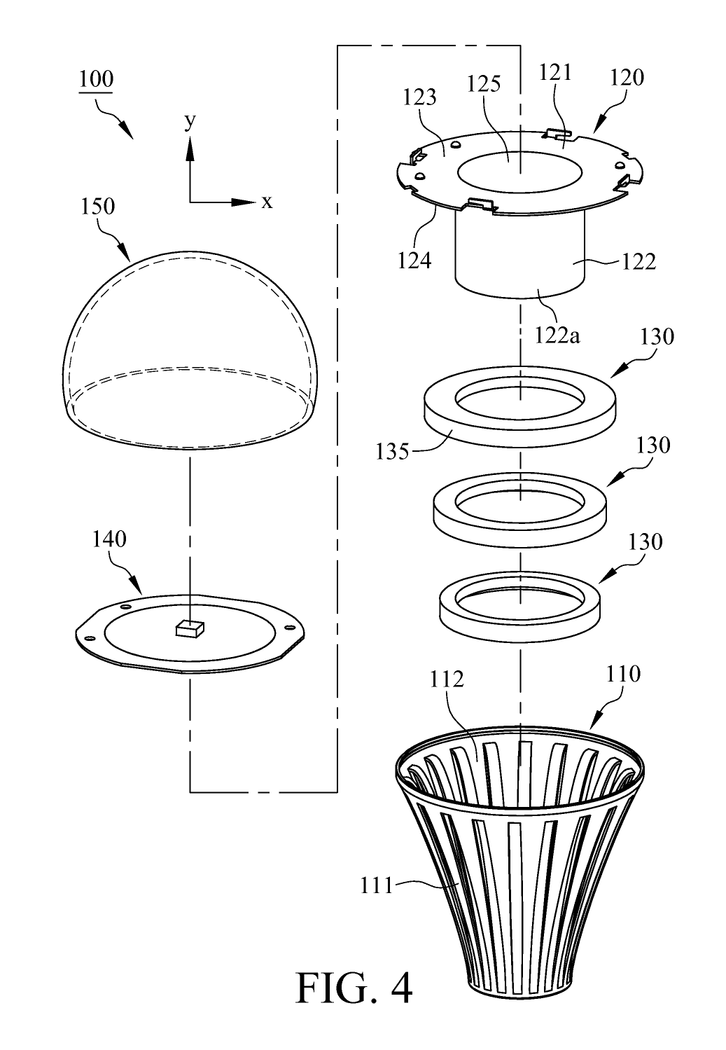

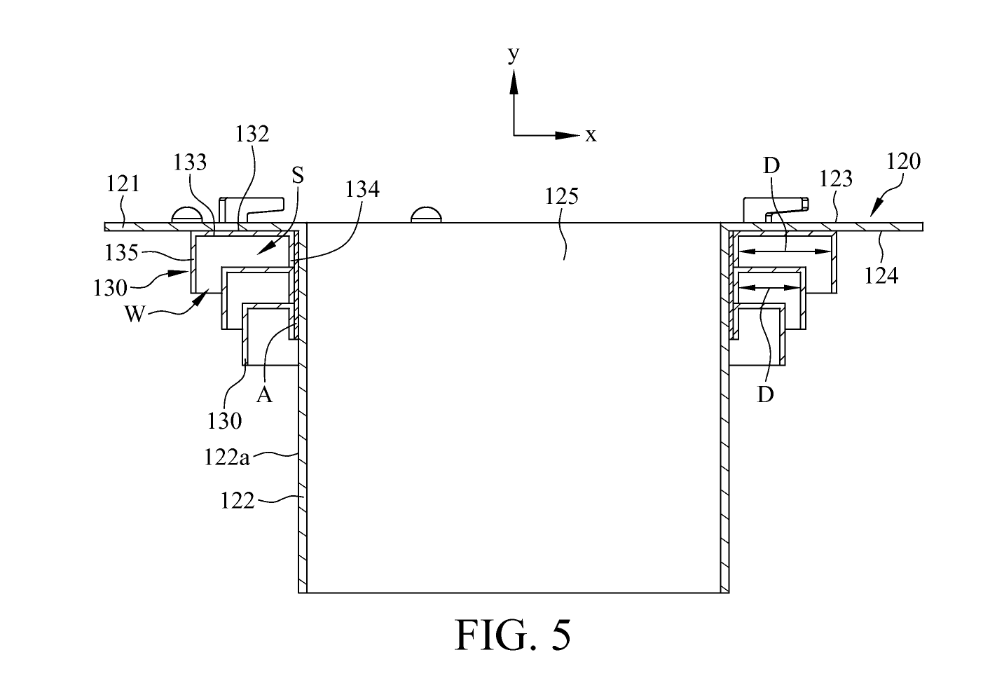

A second embodiment is illustrated in FIGS. 4 and 5, the primary difference between the second embodiment and the first embodiment is that each heat dissipation member 130 further comprises a ring wall 135 protruded to the second surface 133 and formed around the longitudinal axis, wherein adjacent ring walls 135 are spaced apart from each other to define a heat conducting passage W in communication with the heat exchange space S and the accommodating chamber 112. In this embodiment, the ring wall 135 is spaced apart from the extending wall 134 of the heat dissipation member 130 by an interval D, the interval D of the heat dissipation member 130 adjacent to the carrier 121 is the largest one among all heat dissipation members 130, and the interval D of each of the all heat dissipation members 130 decreases along the longitudinal axis y. The heat in the heat exchange space S convects with cold air in the accommodating chamber 112 through the heat conducting passage W so as to increase heat dissipation efficiency.

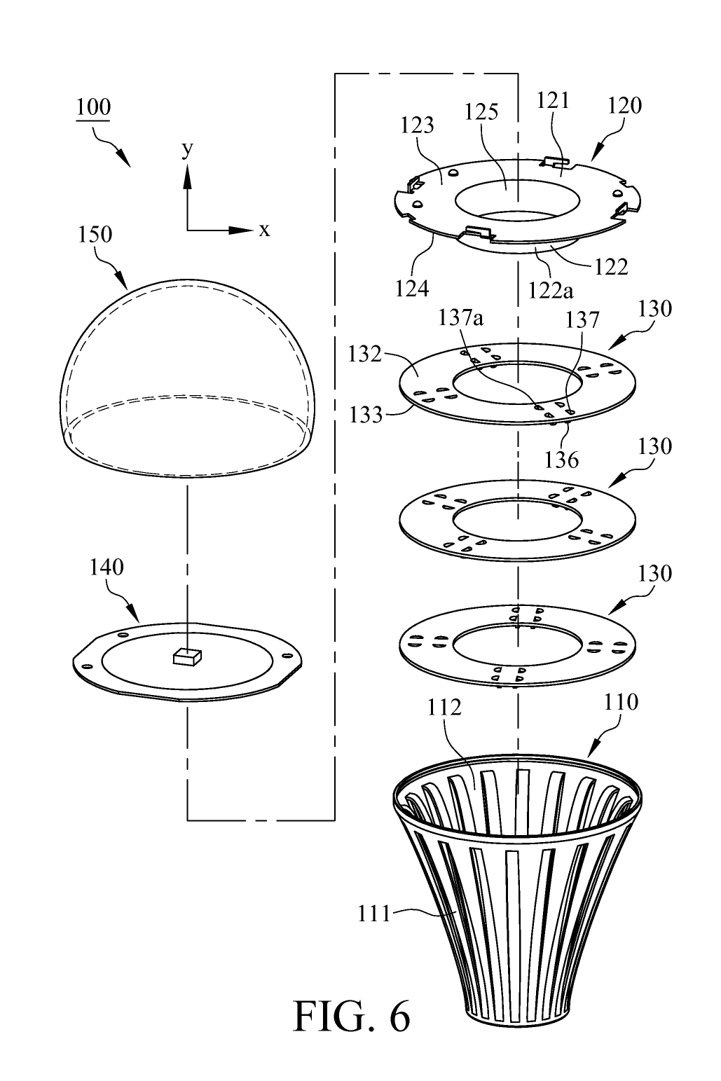

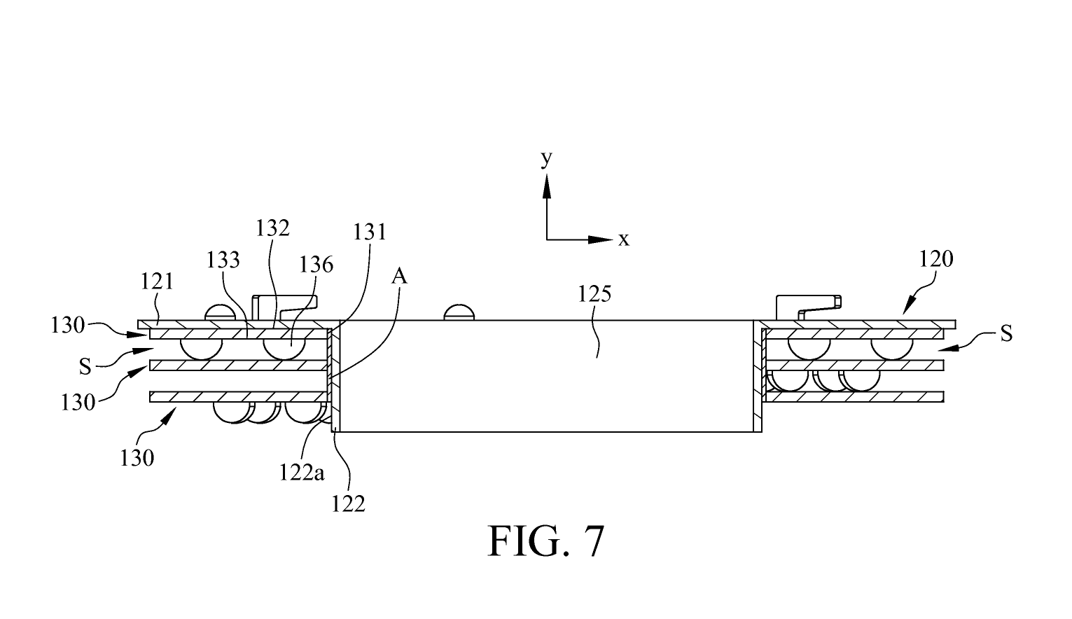

A third embodiment is illustrated in FIGS. 6 and 7, the primary difference between the third embodiment and the first embodiment is that the heat dissipation member 130 further comprises a plurality of heat dissipation plates 136 and a plurality of penetration holes 137 communicated with the first surface 132 and the second surface 133, wherein each penetration hole 137 comprises a hole surface 137a in connection with the heat dissipation plate 136. In this embodiment, each heat dissipation plate 136 protrudes to the second surface 133 of the heat dissipation member 130. The heat dissipation plates 136 and the penetration holes 137 are integrally formed as one piece with the heat dissipation member 130 by means of stamping process. In this embodiment, the heat dissipation member 130 does not possess the extending wall 134 in the first embodiment. The heat exchange space S is defined between adjacent heat dissipation members 130 via the heat dissipation plates 136 for generating heat convection. Meantime, this invention also utilizes the heat dissipation members 130 and the heat dissipation plates 136 to expand heat dissipation area for increasing heat dissipation efficiency.

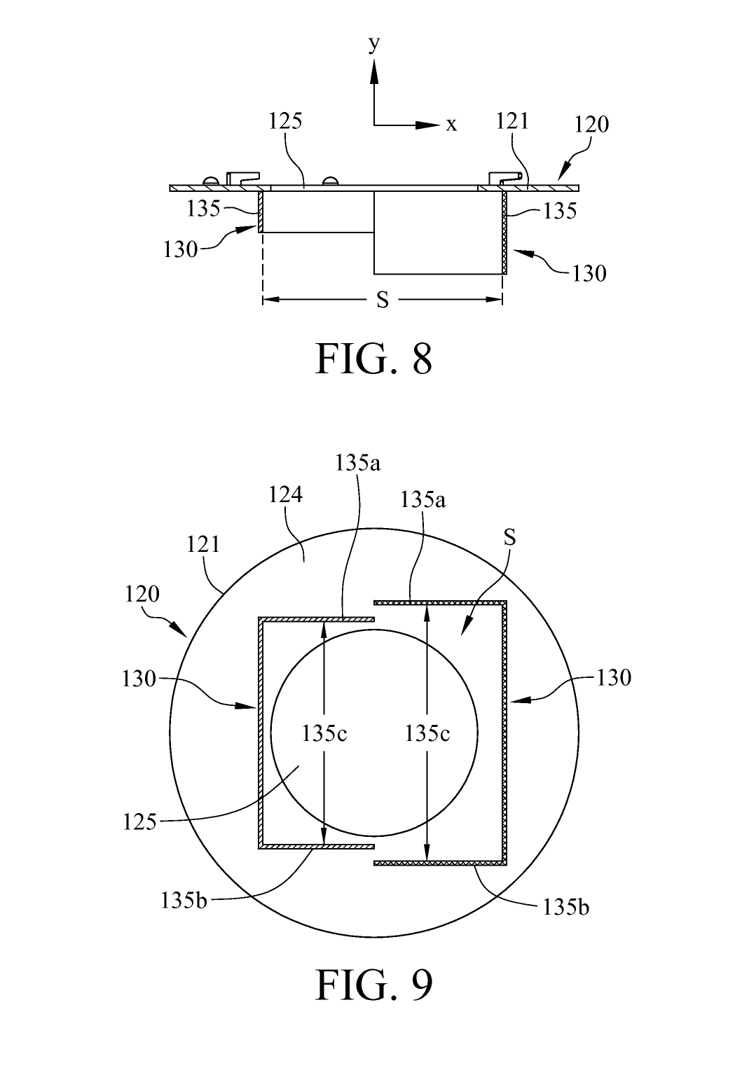

A fourth embodiment is illustrated in FIGS. 8 and 9, the primary difference between the fourth embodiment and the first embodiment is that the heat dissipation members 130 are arranged alternately from each other along a transverse axis x perpendicular to the longitudinal axis y. In this embodiment, each heat dissipation member 130 comprises a ring wall 135 formed along the longitudinal axis y, wherein the ring wall 135 couples to the fixing base 120 and comprises a first end 135a and a second end 135b, the first end 135a and the second end 135b are spaced apart to form a gap 135c communicated with the heat exchange space S and the accommodating chamber 112. The height of the ring wall 135 of the heat dissipation member 130 adjacent to the opening 125 of the fixing base 120 is selectively higher than, lower than or equal to the height of the ring wall 135 of the heat dissipation member 130 far from the opening 125 of the fixing base 120. In this embodiment, the lamp structure 100 introduces the relatively lower ring wall 135 and the relatively smaller gap 135c of the heat dissipation member 130 adjacent to the opening 125 of the fixing base 120. However, the height of the ring wall 135 and the size of the gap 135c are changeable according to requirements. Therefore, the height of the ring wall 135 and the size of the gap 135c in the present invention are not limited to the fourth embodiment. In this embodiment, the heat convection between the heat exchange space S and the accommodating chamber 112 undergoes via the gaps 135c to increase heat dissipation efficiency.

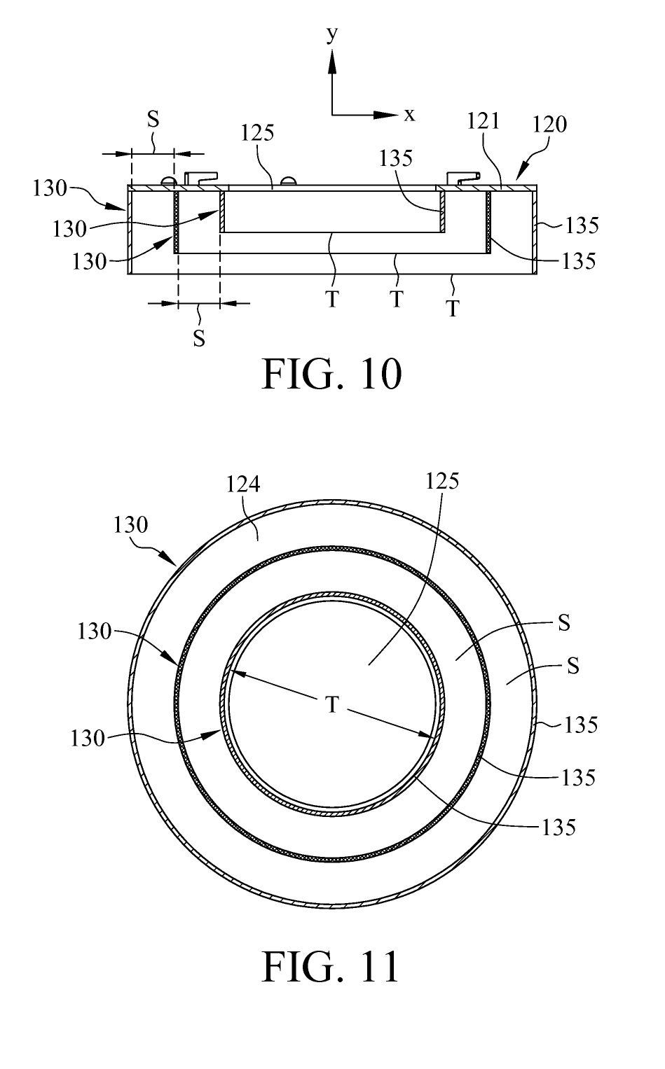

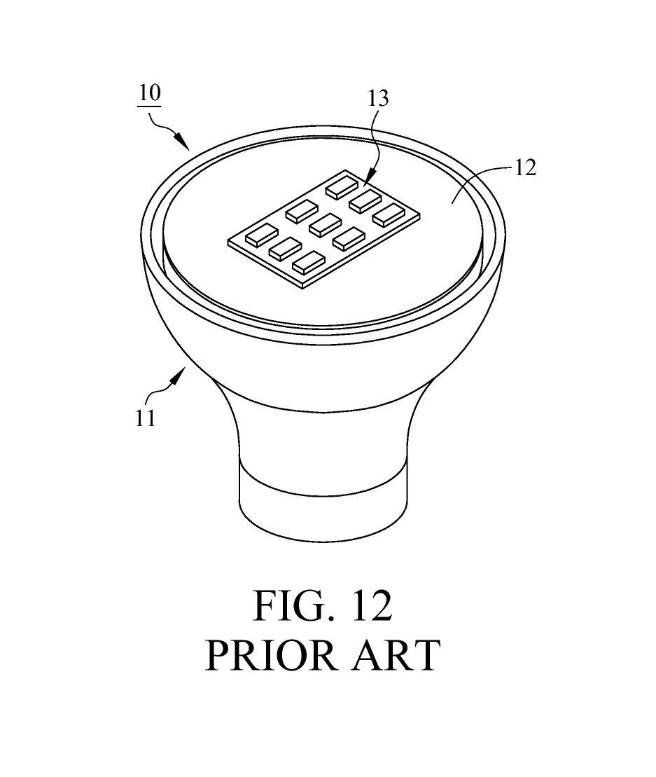

A fifth embodiment is illustrated in FIGS. 10 and 11, the primary difference between the fifth embodiment and the first embodiment is that the heat dissipation members 130 are arranged alternately from each other along a transverse axis x perpendicular to the longitudinal axis y. In this embodiment, each heat dissipation member 130 comprises a ring wall 135 formed along the longitudinal axis y, the ring wall 135 is formed into a closed shape and couples to the fixing base 120. Each ring wall 135 comprises a heat conducting opening T communicated with the heat exchange space S and the accommodating chamber 112. The heat conducting opening T of the heat dissipation member 130 adjacent to the fixing base 120 is smaller than the heat conducting opening T of the heat dissipation member 130 far from the fixing base 120. The height of the ring wall 135 of the heat dissipation member 130 adjacent to the opening 125 of the fixing base 120 is selectively higher than, lower than or equal to the height of the ring wall 135 of the heat dissipation member 130 far from the opening 125 of the fixing base 120. In this embodiment, the lamp structure 100 introduces the relatively lower ring wall 135 of the heat dissipation member 130 adjacent to the opening 125 of the fixing base 120. However, the height of the ring wall 135 is changeable according to requirements. Therefore, the height of the ring wall 135 in the present invention is not limited to the fifth embodiment. In this embodiment, the heat convection between the heat exchange space S and the accommodating chamber 112 undergoes via the heat conducting opening T so as to increase heat dissipation efficiency.

By means of the thermal coupling between the fixing base 120 and the heat dissipation members 130, the heat produced by the lighting module 140 can be conducted to the heat dissipation members 130 through the fixing base 120 and thereafter dissipates via the heat exchange space S to prevent the lighting module 140 from overheat to avoid a relatively lower opto-electronic conversion efficiency or destruction of the lighting module 140.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A lamp structure at least including:
a case having a base and an accommodating chamber surrounded by the base;
a fixing base disposed at the case and having a carrier, wherein the carrier comprises an opening formed around a longitudinal axis; and
a plurality of heat dissipation members coupled to the fixing base, the heat dissipation members are arranged alternately from each other along the longitudinal axis, and a heat exchange space is defined between adjacent heat dissipation members.

2. The lamp structure in accordance with claim 1, wherein the fixing base further comprises an extending portion extending along the longitudinal axis, and the heat dissipation members are coupled to the extending portion.

3. The lamp structure in accordance with claim 2, wherein the carrier comprises an upper surface and a lower surface, the extending portion located at the accommodating chamber extends from the opening and protrudes to the lower surface.

4. The lamp structure in accordance with claim 3, wherein each heat dissipation member comprises a connection hole having a connection surface, the extending portion of the fixing base comprises a coupling surface, and the connection surface is coupled to the coupling surface of the extending portion.

5. The lamp structure in accordance with claim 1, wherein each heat dissipation member comprises an extending wall formed around the longitudinal axis, and the extending wall is coupled to the fixing base.

6. The lamp structure in accordance with claim 4, wherein each heat dissipation member comprises an extending wall formed around the longitudinal axis, and the extending wall is coupled to the fixing base.

7. The lamp structure in accordance with claim 5, wherein each heat dissipation member further comprises a ring wall formed around the longitudinal axis, the adjacent ring walls are spaced apart from each other to define a heat conducting passage in communication with the heat exchange space and the accommodating chamber.

8. The lamp structure in accordance with claim 6, wherein each heat dissipation member further comprises a ring wall formed around the longitudinal axis, the adjacent ring walls are spaced apart from each other to define a heat conducting passage in communication with the heat exchange space and the accommodating chamber.

9. The lamp structure in accordance with claim 7, wherein the ring wall is spaced apart from the extending wall by an interval, the interval of the heat dissipation member adjacent to the carrier is the largest one among all heat dissipation members, and the interval of each of the heat dissipation members decreases along the longitudinal axis.

10. The lamp structure in accordance with claim 8, wherein the ring wall is spaced apart from the extending wall by an interval, the interval of the heat dissipation member adjacent to the carrier is the largest one among all heat dissipation members, and the interval of each of the heat dissipation members decreases along the longitudinal axis.

11. The lamp structure in accordance with claim 1, wherein each heat dissipation member comprises a first surface and a second surface, the first surface of the heat dissipation member adjacent to the carrier is in contact with the carrier of the fixing base.

12. The lamp structure in accordance with claim 11, wherein each heat dissipation member further comprises a plurality of heat dissipation plates protruded to the second surface.

13. The lamp structure in accordance with claim 12, wherein each heat dissipation member comprises a plurality of penetration holes communicated with the first surface and the second surface, each penetration hole comprises a hole surface in connection with the heat dissipation plate.

14. A lamp structure at least including:
a case having a base and an accommodating chamber surrounded by the base;
a fixing base disposed at the case and having a carrier, wherein the carrier comprises an opening formed around a longitudinal axis; and
a plurality of heat dissipation members coupled to the fixing base, the heat dissipation members are arranged alternately from each other along a transverse axis perpendicular to the longitudinal axis, and a heat exchange space is defined between adjacent heat dissipation members.

15. The lamp structure in accordance with claim 14, wherein each heat dissipation member comprises a ring wall formed around the longitudinal axis, the ring wall is coupled to the fixing plate and comprises a first end and a second end, the first end and the second end are spaced apart to form a gap.

16. The lamp structure in accordance with claim 14, wherein each heat dissipation member comprises a ring wall formed around the longitudinal axis, the ring wall is formed into a closed shape and couples to the fixing base.

17. The lamp structure in accordance with claim 16, wherein each ring wall comprises a heat conducting opening, the heat conducting opening of the heat dissipation member adjacent to the opening of the fixing base is smaller than the heat conducting opening of the heat dissipation member far from the opening of the fixing base.

18. The lamp structure in accordance with claim 15, wherein the height of the ring wall of the heat dissipation member adjacent to the opening of the fixing base is selectively higher than, lower than or equal to the height of the ring wall of the heat dissipation member far from the opening of the fixing base.

19. The lamp structure in accordance with claim 16, wherein the height of the ring wall of the heat dissipation member adjacent to the opening of the fixing base is selectively higher than, lower than or equal to the height of the ring wall of the heat dissipation member far from the opening of the fixing base.
